(19) United States
(12) Patent Application Publication
(10) Pub. No.: US 2016/0003091 A1
(43) Pub. Date: Jan. 7, 2016

(54) NACELLE INTERNAL AND EXTERNAL FLOW CONTROL

(71) Applicant: UNITED TECHNOLOGIES CORPORATION, Hartford, CT (US)

(72) Inventor: Robert E. Malecki, Storrs, CT (US)

(21) Appl. No.: 14/768,132

(22) PCT Filed: Mar. 11, 2014
(86) PCT No.: PCT/US2014/023429

§ 371 Date: Aug. 14, 2015

Related U.S. Application Data
(60) Provisional application No. 61/788,240, filed on Mar. 15, 2013.

(51) Int. Cl. F01D 17/10; F01D 15/08; F01D 25/24

(52) U.S. Cl. CPC F01D 17/10; F01D 25/24; F01D 15/08; F05D 2220/32

(57) ABSTRACT

A nacelle (12) for a gas turbine engine (10) that extends along an engine centerline (CO includes an inner portion (28), an outer portion (30), and a nacelle flow control system (26). The outer portion (30) surrounds the inner portion (28) and connects to the inner portion (28) at a leading edge (32). The nacelle flow control system (26) includes an internal flow control (38) for the inner portion (28) and an external flow control (40) for the outer portion (30).

### BACKGROUND

This disclosure relates to gas turbine engines, and, in particular, to a flow control system for a nacelle.

Gas turbine engines for commercial aircraft applications typically include an engine core housed within a core nacelle. In one type of arrangement known as a turbofan engine, the core drives a large fan upstream from the core that provides airflow into the core. A significant portion of airflow bypasses the core to provide thrust. One or more spools are arranged within the core, and a gear train may be provided between one of the spools and the fan. A fan nacelle surrounds the fan and at least a portion of the core.

Due to its relatively large size, the fan nacelle can cause a significant amount of drag during flight. This problem is compounded by the fact that the engine experiences diversified conditions depending on the stage of the flight cycle the aircraft is in. More specifically, there are substantial differences in airflow at takeoff and initial climb conditions compared to airflow when cruising at altitude. It is difficult to design a static nacelle structure that can perform well during the entire flight cycle.

### SUMMARY

In one embodiment of the present invention, a nacelle for a gas turbine engine that extends along an engine centerline includes an inner portion, an outer portion, and a nacelle flow control system. The outer portion surrounds the inner portion and connects to the inner portion at a leading edge. The nacelle flow control system includes an internal flow control for the inner portion and an external flow control for the outer portion.

In another embodiment, a method of operating a nacelle flow control system for an aircraft includes flowing air through an internal flow control during a takeoff phase of flight and during an initial climb phase of flight. The method also includes flowing air through an external flow control during a cruising phase of flight.

### BRIEF DESCRIPTION OF THE DRAWINGS

FIG. 1 is a cross section view of a gas turbine engine showing a nacelle flow control system.

FIG. 2 is a front elevation view of the nacelle.

FIG. 3 is a cross section view of a gas turbine engine showing an alternate embodiment nacelle flow control system.

### DETAILED DESCRIPTION

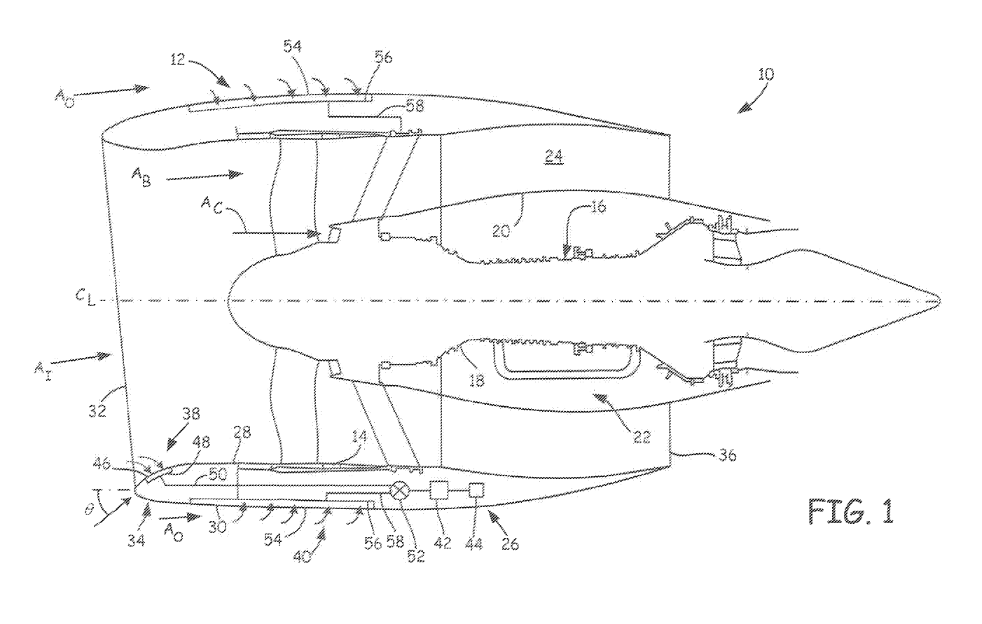

In FIG. 1, a cross section view illustrates one embodiment of gas turbine engine 10. Gas turbine engine 10 extends along engine centerline C_{L} and includes nacelle 12, fan case 14, core 16, intermediate case 18, core nacelle 20, core compartment 22, fan duct 24, and nacelle flow control system 26. In the embodiment shown in FIGS. 1-3, gas turbine engine 10 is a high bypass ratio turbofan gas turbine engine but the disclosed embodiments are applicable to other types of gas turbine engines.

Nacelle 12 encloses fan case 14, which is disposed adjacent to engine core 16 or backbone. Core 16 is generally comprised of a compressor section, a combustor, and a turbine section and known sub-structures (although these sections are not shown in detail). One of such sub-structures is intermediate case 18, which encloses portions of compressor section aft of fan case 14. Another of such sub-structures is core nacelle 20 that surrounds the core 16 and provides for core compartment 22.

In general, during operation airflow is drawn into gas turbine engine 10 through nacelle 12. A portion of the airflow, comprising airflow A_{B}, bypasses core 16 and passes through nacelle 12 along fan duct 24 and produces a majority of the forward thrust. A second portion of the airflow, comprising airflow A_{C}, enters core 16 (the details of which are not shown). Inside of core 16, airflow A_{C} is pressurized in the compressor sections (low and high pressure compressors). Fuel is mixed with the pressurized air and combusted within the combustor. The combustion gases are discharged through one or more the turbine sections (e.g., high and low pressure turbines), which extract energy therefrom for powering the compressor sections and/or the fan section.

The disclosed nacelle 12 includes a nacelle flow control system 26. More specifically, nacelle 12 includes inner portion 28 and surrounding outer portion 30. Inner portion 28 connects to outer portion 30 at leading edge 32 of lip/bull nose 34 and at trailing edge 36. Nacelle flow control system 26 includes internal flow control 38 and external flow control 40. Both internal flow control 38 and external flow control 40 are fluidly connected to pump 42. Pump 42 is fluidly connected to orifice structure 44, which can be a pneumatic inlet/outlet of a suitable type known to one skilled in the art. The particular location and configuration of orifice structure 44 can vary as desired for particular applications.

Internal flow control 38 includes inner panel 46 on inner portion 28 at lip 34 that can be configured as a perforated sheet with apertures that allow air flow into or out of inner plenum 48. Inner plenum 48 is fluidly connected to inner passage 50, which in turn is fluidly connected to control valve 52. External flow control 40 includes outer panel 54 on outer portion 30 that can be configured as a perforated sheet with apertures that allow air flow into outer plenum 56. Outer plenum 56 is fluidly connected to outer passage 58, which in turn is also fluidly connected to control valve 52. In the illustrated embodiment, inner panel 46 is on lip 34, proximate to leading edge 32, while outer panel 54 is proximate to the axial midpoint of nacelle 12. Thereby, inner panel 46 is located axially forward of outer panel 54.

Control valve 52 is fluidly connected to pump 42 and can direct flow through nacelle flow control system 26. In the illustrated embodiment, control valve 52 can direct airflow through internal flow control 38 only or external flow control 40 only, or control valve 52 can block flow through both flow controls 38, 40.

During operation of gas turbine engine 10, air is flowed through nacelle flow control system 26. More specifically, during high angle of attack stages of the flight cycle such as takeoff and initial climb, where incoming air angle θ can be between about 15° to 25° (measured relative to engine centerline C_{L}), internal flow control 38 is utilized. Internal flow control 38 can also be utilized during the highest angle of attack operation near the aircraft wing buffet/stall boundary, wherein the incoming air angle θ can be between 25° and 35°. This occurs by control valve 52 fluidly connecting internal flow control 38 to pump 42, and pump 42 creating a vacuum that intakes or suction air into internal flow control 38 and expels it through orifice structure 44. The action of taking in air on the inside of lip 34 modifies airflow A_{I} coming into nacelle 12. More specifically, separation of incoming airflow A_{I} from inner portion 28 of nacelle 26 is reduced or prevented during conditions when incoming air angle θ is high.

On the other hand, during a cruising stage of flight, where incoming air angle θ is low, flow through internal flow control 38 can cease and external flow control 40 can be utilized. This occurs by control valve 52 actuating to fluidly disconnect internal flow control 38 from pump 42 and instead fluidly connecting external flow control 40 to pump 42. Then pump 42 creates a vacuum that intakes air into external flow control 40 and expels it through orifice structure 44. The action of taking in air on outer portion 30 modifies outside airflow A_{O} that is passing by the exterior of gas turbine engine 10.

More specifically, turbulence is reduced or prevented and/or laminar flow is maintained in outside airflow A_{O} around outer portion 30 of nacelle 12. In the illustrated embodiment, internal flow control 38 and external flow control 40 are configured for a substantially different purposes and are used during substantially different stages of the flight cycle. Control valve 52, therefore, does not typically allow airflow through flow controls 38, 40 simultaneously.

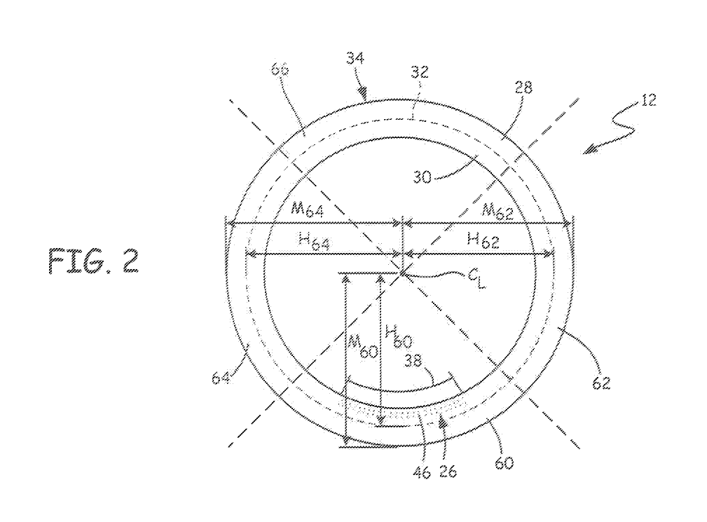

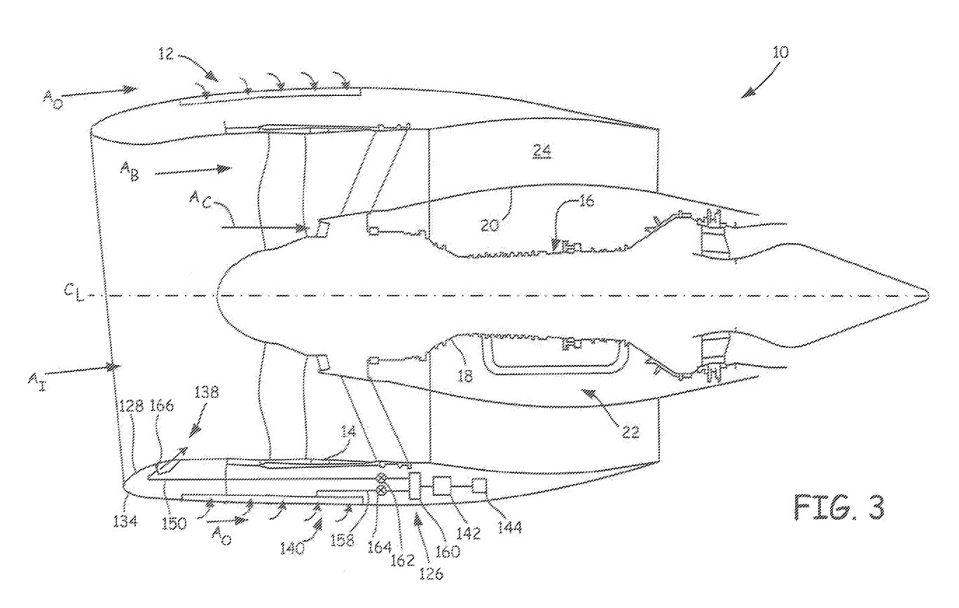

The components and configuration of nacelle flow control system 26 allow for improved airflow through and around nacelle 12. This reduces the aerodynamic drag of nacelle 12 during operation of gas turbine engine 12, improving the fuel economy of gas turbine engine 12. Depicted in FIG. 1 is one embodiment, to which there are alternatives. For example, as shown in FIG. 3, internal flow control 38 can expel air instead of taking in air. In such an embodiment, pump 42 draws air into nacelle flow control system 26 through orifice structure 44 during operation of internal flow control 38. In FIG. 2, a front elevation view of nacelle 12 is shown. In FIG. 2 nacelle 12 has been divided into four quadrants: bottom side 60, left side 62, right side 64, and top side 66. External flow control 40 (shown in FIG. 1) of nacelle flow control system 26 extends substantially around the entire circumference of nacelle 12 such that external flow control 40 is located on each side 60, 62, 64, 66 of nacelle 12. In the illustrated embodiment, internal flow control 38 of nacelle flow control system 26 is located only on bottom side 60, in a localized manner. In an alternate embodiment nacelle flow control system 26, internal flow control 38 is enlarged and is located at least partly in left side 62 and right side 64 in addition to bottom side 60.

As stated previously, internal flow control 38 helps reduce or prevent flow separation of air entering nacelle 12 at high incoming air angle θ (shown in FIG. 1), which can occur at certain stages of the flight cycle as well as during high crosswind weather conditions. Internal flow control 38 allows for lip 34 to be thinner than conventional designs proximate to where internal flow control 38 is located. A normalized measurement of lip 34 thickness on bottom side 60 is measured by a ratio of highlight radius H₆₀ (which is a distance from engine centerline C_{L} to leading edge 32) to maximum radius M₆₀ (which is a maximum distance from engine centerline C_{L} to outer portion 30). In the illustrated embodiment, the value of the ratio or H₆₀ to M₆₀ is between approximately 0.85 and 0.90. Similarly, highlight radius H₆₂ and maximum radius M₆₂ of left side 62 can be measured and compared, and so can highlight radius H₆₄ and maximum radius M₆₄ of right side 64. In an alternative embodiment where internal flow control 38 is also located on left side 62, the ratio of highlight radius H₆₂ to maximum radius M₆₂ is between approximately 0.85 and 0.90. Similarly, in an alternative embodiment where internal flow control 38 is also located on right side 64, the ratio of highlight radius H₆₄ to maximum radius M₆₄ is between approximately 0.85 and 0.90.

In FIG. 3, a cross section view of gas turbine engine 10 is shown, including an alternate embodiment nacelle flow control system 126. In nacelle flow control system 126, pump 142 is fluidly connected to manifold 160, and inner passage 150 and outer passage 158 are fluidly connected to manifold 160. Inner passage 150 includes inner control valve 162 that controls airflow through internal flow control 138, and outer passage 158 includes outer control valve 164 that controls airflow through external flow control 140. In the illustrated embodiment, pump 142 can function as both a vacuum for external flow control 140 and as a blower for internal flow control 138. When pump 142 is functioning as a blower, air is drawn from orifice structure 144 (functioning as an inlet), blown through internal flow control 138, and expelled through a plurality of elongated ports 166 in lip 134 (although only one port 166 is shown in FIG. 3 for simplicity). Each port 166 is recessed into inner portion 128, and expels a jet of air that is directionally oriented toward engine centerline C_{L} and core 16. These jets of air help reduce or prevent flow separation of air entering nacelle 12 at high incoming air angle θ (shown in FIG. 1). As an alternative to the embodiment shown in FIG. 3, internal flow control 138 can be configured similarly to internal flow control 38 of FIG. 1, including inner panel 46 and inner plenum 48 instead of ports 166.

### DISCUSSION OF POSSIBLE EMBODIMENTS

The following are non-exclusive descriptions of possible embodiments of the present invention.

A nacelle for a gas turbine engine, the nacelle including an inner portion, a surrounding outer portion, and a leading edge connecting therebetween according to an exemplary embodiment of this disclosure, among other possible things includes a nacelle flow control system that includes: an internal flow control for the inner portion for modifying a first airflow, the internal flow control including a first passage for flowing air; and an external flow control for the outer portion for modifying a second airflow, the external flow control including a second passage for flowing air.

The nacelle of the preceding paragraph can optionally include, additionally and/or alternatively, any one or more of the following features, configurations and/or additional components:

A further embodiment of the foregoing nacelle, wherein the nacelle flow control system can further comprise: a pump that provides airflow through at least one of the first and second passages of the nacelle flow control system; and a control valve connected to at least one of the first and second passages and configured to direct flow through the nacelle flow control system.

A further embodiment of any of the foregoing nacelles, wherein the flow control valve can be connected to the first and second passages and can direct flow through the internal flow control or the external flow control or to neither the internal nor the external flow controls.

A further embodiment of any of the foregoing nacelles, wherein the nacelle flow control system can further comprise: a manifold fluidly connected to the pump and to the control valve, wherein the control valve is fluidly connected to the internal flow control; and a second control valve fluidly connected to the manifold, wherein the second control valve is fluidly connected to the internal flow control.

A further embodiment of any of the foregoing nacelles, wherein the internal flow control can comprise: a plenum fluidly connected to the first passage; and a plurality of apertures through a panel in the inner portion of nacelle that are fluidly connected to the plenum.

A further embodiment of any of the foregoing nacelles, wherein the internal flow control can be configured to suction air to modify the first airflow by reducing or minimizing separation.

A further embodiment of any of the foregoing nacelles, wherein the internal flow control can comprise: a plurality of ports through the inner portion of nacelle fluidly that are connected to the first passage and that are oriented toward the engine centerline.

A further embodiment of any of the foregoing nacelles, wherein the internal flow control can be configured to blow air to modify the first airflow by reducing or minimizing separation.

A further embodiment of any of the foregoing nacelles, wherein the external flow control can comprise: a plenum fluidly connected to the second passage; and a plurality of apertures through a panel in the outer portion of nacelle that are fluidly connected to the plenum.

A further embodiment of any of the foregoing nacelles, wherein the external flow control can extend substantially around the entire circumference of the outer portion of the nacelle.

A further embodiment of any of the foregoing nacelles, wherein the internal flow control can be localized on a bottom side of the inner portion of the nacelle.

A further embodiment of any of the foregoing nacelles, wherein nacelle can further comprise: a first highlight radius between an engine centerline and the leading edge at a bottom side of the nacelle; a second maximum radius between the engine centerline and the radially outermost position at the bottom side of the nacelle; wherein a first ratio of highlight-radius-to-maximum-radius is between approximately 0.85 and 0.90.

A further embodiment of any of the foregoing nacelles, wherein the internal flow control can be also localized on a lateral side of the inner portion of the nacelle.

A further embodiment of any of the foregoing nacelles, wherein nacelle can further comprise: a second highlight radius between the engine centerline and the leading edge at a lateral side of the nacelle; a second maximum radius between the engine centerline and the radially outermost position at the lateral side of the nacelle; wherein a second ratio of highlight-radius-to-maximum-radius is between approximately 0.85 and 0.90.

A method of operating a nacelle flow control system for an aircraft according to an exemplary embodiment of this disclosure, among other possible things includes flowing air through an internal flow control during a takeoff phase of flight and during an initial climb phase of flight; and flowing air through an external flow control during a cruising phase of flight.

The method of the preceding paragraph can optionally include, additionally and/or alternatively, any one or more of the following features, configurations and/or additional components:

A further embodiment of the foregoing method, wherein the method can further comprise: ceasing flowing air through the internal flow control prior to initiating flowing air through the external flow control.

A further embodiment of any of the foregoing methods, wherein a pump can flow air through the internal flow control during the takeoff and initial climb phases of flight, and the pump can flow air through the external flow control during the cruising phase of flight.

A further embodiment of any of the foregoing methods, wherein flowing air through the internal flow control can include taking air into the nacelle flow control system.

A further embodiment of any of the foregoing methods, wherein flowing air through the internal flow control can include expelling air out of the nacelle flow control system.

A further embodiment of any of the foregoing methods, wherein flowing air through the external flow control can include taking air into the nacelle flow control system.

A nacelle for a gas turbine engine, the nacelle including an inner portion, a surrounding outer portion, and a leading edge connecting therebetween; the nacelle according to an exemplary embodiment of this disclosure, among other possible things includes: a nacelle flow control system that includes: an internal flow control for the inner portion; and an external flow control for the outer portion; both portions include a passage for suctioning and/or blowing air; thereby reducing and/or preventing turbulence and/or freestream airflow separation thereat.

Although the present invention has been described with reference to preferred embodiments, workers skilled in the art will recognize that changes may be made in form and detail without departing from the spirit and scope of the invention.

1. A nacelle for a gas turbine engine, the nacelle including an inner portion, a surrounding outer portion, and a leading edge connecting therebetween; the nacelle comprising:
a nacelle flow control system that includes:
an internal flow control for the inner portion for modifying a first airflow, the internal flow control including a first passage for flowing air; and
an external flow control for the outer portion for modifying a second airflow, the external flow control including a second passage for flowing air.

2. The nacelle of claim 1, wherein the nacelle flow control system further comprises:
a pump that provides airflow through at least one of the first and second passages of the nacelle flow control system; and
a control valve connected to at least one of the first and second passages and configured to direct flow through the nacelle flow control system.

3. The nacelle of claim 2, wherein the flow control valve is connected to the first and second passages and directs flow through the internal flow control or the external flow control or to neither the internal nor the external flow controls.

4. The nacelle of claim 2, wherein the nacelle flow control system further comprises:
a manifold fluidly connected to the pump and to the control valve, wherein the control valve is fluidly connected to the internal flow control; and
a second control valve fluidly connected to the manifold, wherein the second control valve is fluidly connected to the external flow control.

5. The nacelle of claim 2, wherein the internal flow control comprises:
a plenum fluidly connected to the first passage; and
a plurality of apertures through a panel in the inner portion of nacelle that are fluidly connected to the plenum.

6. The nacelle of claim 5, wherein the internal flow control is configured to suction air to modify the first airflow by reducing or minimizing separation.

7. The nacelle of claim 2, wherein the internal flow control comprises:
a plurality of ports through the inner portion of nacelle fluidly that are connected to the first passage and that are oriented toward the engine centerline.

8. The nacelle of claim 7, wherein the internal flow control is configured to blow air to modify the first airflow by reducing or minimizing separation.

9. The nacelle of claim 2, wherein the external flow control comprises:
a plenum fluidly connected to the second passage; and
a plurality of apertures through a panel in the outer portion of nacelle that are fluidly connected to the plenum.

10. The nacelle of claim 9, wherein the external flow control extends substantially around the entire circumference of the outer portion of the nacelle.

11. The nacelle of claim 1, wherein the internal flow control is localized on a bottom side of the inner portion of the nacelle.

12. The nacelle of claim 11, and further comprising:
a first highlight radius between an engine centerline and the leading edge at a bottom side of the nacelle;
a second maximum radius between the engine centerline and the radially outermost position at the bottom side of the nacelle;
wherein a first ratio of highlight-radius-to-maximum-radius is between approximately 0.85 and 0.90.

13. The nacelle of claim 11, wherein the internal flow control is also localized on a lateral side of the inner portion of the nacelle.

14. The nacelle of claim 13, and further comprising:
a second highlight radius between the engine centerline and the leading edge at a lateral side of the nacelle;
a second maximum radius between the engine centerline and the radially outermost position at the lateral side of the nacelle;
wherein a second ratio of highlight-radius-to-maximum-radius is between approximately 0.85 and 0.90.

15. A method of operating a nacelle flow control system for an aircraft, the method comprising:
flowing air through an internal flow control during a takeoff phase of flight and during an initial climb phase of flight; and
flowing air through an external flow control during a cruising phase of flight.

16. The method of claim 15, and further comprising:
ceasing flowing air through the internal flow control prior to initiating flowing air through the external flow control.

17. The method of claim 15, wherein a pump flows air through the internal flow control during the takeoff and initial climb phases of flight, and the pump flows air through the external flow control during the cruising phase of flight.

18. The method of claim 15, wherein flowing air through the internal flow control includes taking air into the nacelle flow control system.

19. The method of claim 15, wherein flowing air through the internal flow control includes expelling air out of the nacelle flow control system.

20. The method of claim 15, wherein flowing air through the external flow control includes taking air into the nacelle flow control system.

21. A nacelle for a gas turbine engine, the nacelle including an inner portion, a surrounding outer portion, and a leading edge connecting therebetween; the nacelle comprising:
a nacelle flow control system that includes:
an internal flow control for the inner portion; and
an external flow control for the outer portion;
both portions include a passage for suctioning and/or blowing air;
thereby reducing and/or preventing turbulence and/or freestream airflow separation thereat.
